(19) United States
(12) Patent Application Publication
(10) Pub. No.: US 2010/0068552 A1
(43) Pub. Date: Mar. 18, 2010

(54) MODULE INCLUDING A STABLE SOLDER JOINT

(75) Inventors: Jens Goerlich, Bueren (DE); Karsten Guth, Soest (DE); Olaf Hohlfeld, Warstein (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: INFINEON TECHNOLOGIES AG, Neubiberg (DE)

(21) Appl. No.: 12/622,203

(22) Filed: Nov. 19, 2009

Related U.S. Application Data
(63) Continuation-in-part of application No. 12/059,188, filed on Mar. 31, 2008.

(51) Int. Cl. B32B 15/01; B23K 35/28

(52) U.S. Cl. 428/615; 148/24

(57) ABSTRACT

A solder includes a soft solder having a melting point less than 450° C. and particles embedded in the soft solder. Each particle has a maximum length greater than 50 μm. The particles comprise greater than 10 Vol % and less than 60 Vol % of the solder.

### CROSS-REFERENCE TO RELATED APPLICATIONS

This Utility patent application is a continuation-in-part of U.S. patent application Ser. No. 12/059,188, entitled “MODULE INCLUDING A ROUGH SOLDER JOINT,” filed Mar. 31, 2008, which is incorporated herein by reference.

### BACKGROUND

Power electronic modules are semiconductor packages that are used in power electronic circuits. Power electronic modules are typically used in vehicular and industrial applications, such as in inverters and rectifiers. The semiconductor components included within the power electronic modules are typically insulated gate bipolar transistor (IGBT) semiconductor chips or metal-oxide-semiconductor field effect transistor (MOSFET) semiconductor chips. The IGBT and MOSFET semiconductor chips have varying voltage and current ratings. Some power electronic modules also include additional semiconductor diodes (i.e., free-wheeling diodes) in the semiconductor package for overvoltage protection.

In general, two different power electronic module designs are used. One design is for higher power applications and the other design is for lower power applications. For higher power applications, a power electronic module typically includes several semiconductor chips integrated on a single substrate. The substrate typically includes an insulating ceramic substrate, such as Al₂O₃, AlN, Si₃N₄, or other suitable material, to insulate the power electronic module. At least the top side of the ceramic substrate is metallized with either pure or plated Cu, Al, or other suitable material to provide electrical and mechanical contacts for the semiconductor chips. The metal layer is typically bonded to the ceramic substrate using a direct copper bonding (DCB) process, a direct aluminum bonding (DAB) process, or an active metal brazing (AMB) process.

Typically, soft soldering with Sn—Pb, Sn—Ag, Sn—Ag—Cu, or another suitable solder alloy is used for joining a semiconductor chip to a metallized ceramic substrate. Typically, the module includes one or more substrates that are arranged on a metal base plate. In this case, the backside of the ceramic substrate is also metallized with either pure or plated Cu, Al, or other suitable material for joining the substrates to the metal base plate. To join the substrates to the metal base plate, soft soldering with Sn—Pb, Sn—Ag, Sn—Ag—Cu, or another suitable solder alloy is typically used.

For vehicular applications, such as hybrid electric vehicles, the coolant of the combustion engine may be used for cooling the power semiconductor modules. Junction temperatures up to 200° C. may be exhibited within the power semiconductor chips. The solder layer between the substrate and the metal base plate experience the temperature of the coolant plus approximately 10° C., which results from the thermal impedance from the substrate to the metal base plate and coolant. The temperature at the substrate is typically around 110° C., but may reach a maximum temperature of up to around 140° C. Therefore, compared to a typical industrial application, the solder layer may experience a wider range of temperature and a temperature swing of approximately 30° C. to 60° C. more than for the industrial application. The additional 30° C. to 60° C. in temperature swing roughly doubles the temperature swing compared to a typical industrial application.

Due to the wide temperature swing during thermal cycling, the lifetime of the power electronic module may be reduced. Cracks may form inside the solder layer after repeated thermal cycles. The cracks can easily spread over the entire solder layer and lead to the failure of the power electronic module. With the increasing desire to use power electronics in harsh environments (e.g., automotive applications) and the ongoing integration of semiconductor chips, the temperature swing experienced by the power electronic modules will continue to increase. Therefore, there is a growing demand for power electronic modules capable of withstanding thermal cycling having a temperature swing greater than or equal to approximately 100° C.

For these and other reasons, there is a need for the present invention.

### SUMMARY

One embodiment provides a solder. The solder includes a soft solder having a melting point less than 450° C. and particles embedded in the soft solder. Each particle has a maximum length greater than 50 μm. The particles comprise greater than 10 Vol % and less than 60 Vol % of the solder.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 illustrates a cross-sectional view of one embodiment of a module.

FIG. 2 illustrates a cross-sectional view of another embodiment of a module.

FIG. 3 illustrates a cross-sectional view of one embodiment of a solder joint.

FIG. 4 illustrates a cross-sectional view of one embodiment of a portion of a module including a metallized substrate including roughness enhancing features.

FIG. 5A illustrates a bottom view of one embodiment of a metallized substrate including a metal layer having roughness enhancing features.

FIG. 5B illustrates a bottom view of another embodiment of a metallized substrate including a metal layer having roughness enhancing features.

FIG. 5C illustrates a bottom view of another embodiment of a metallized substrate including a metal layer having roughness enhancing features.

FIG. 6 is a graph illustrating one embodiment of soldering temperatures versus time for forming an inter-metallic zone.

FIG. 7 illustrates a perspective view of one embodiment of a solder pad.

FIG. 8A illustrates a cross-sectional view of one embodiment of the solder pad illustrated in FIG. 7 in a sectional plane E.

FIG. 8B illustrates one embodiment of a metallic particle that is embedded in soft solder.

FIG. 8C illustrates one embodiment of a metallized particle that is embedded in soft solder.

FIGS. 9A and 9B illustrate one embodiment of a method for producing a solder joint between a part of a module and a metal base plate.

FIG. 10 illustrates one embodiment of a method for producing a solder pad that includes particles.

FIG. 11 illustrates one embodiment of a block of soft solder that includes particles.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

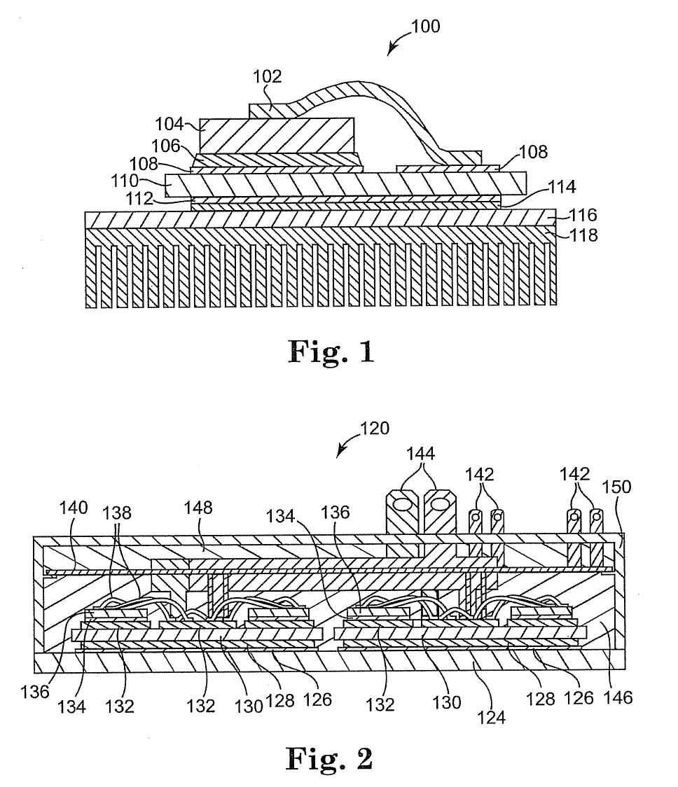

FIG. 1 illustrates a cross-sectional view of one embodiment of a module 100. In one embodiment, module 100 is a power electronic module. Power electronic module 100 includes a bond wire 102, a semiconductor chip 104, a solder joint 106, a metalized ceramic substrate 110 including metal surfaces or layers 108 and 112, a solder joint 114, a metal base plate 116, and a heat sink 118. In one embodiment, solder joint 106 is replaced by a sintered joint formed using a low temperature silver sintering process (e.g., LTJT, NTV). In another embodiment, a transient liquid phase soldering process, which results in an alloy with a melting point greater than 400° C., is used to form joint 106. Solder joint 114 joins metal layer 112 to metal base plate 116. In one embodiment, solder joint 114 includes soft solder and an inter-metallic zone having spikes greater than 10 μm, such as up to 100 μm, and a roughness (R_{z}) of at least 20 μm, where R_{z} is defined by DIN EN ISO 4287.

In another embodiment, metal layer 112 includes roughness enhancing features, such as trenches, dimples, or other suitable features to increase the roughness of solder joint 114. In one embodiment, the roughness enhancing features are combined with an inter-metallic zone having spikes greater than 10 μm, such as up to 100 μm, to provide a roughness (R_{z}) of at least 20 μm. The roughness of solder joint 114 reduces the stress on the solder joint due to thermal cycling, thereby extending the life of power electronic module 100 by preventing a failure of the solder joint.

As used herein, the term “electrically coupled” is not meant to mean that the elements must be directly coupled together and intervening elements may be provided between the “electrically coupled” elements.

Semiconductor chip 104 includes one or more insulated gate bipolar transistors (IGBTs), metal-oxide-semiconductor field effect transistors (MOSFETs), diodes, or other suitable power semiconductors. A contact on top of semiconductor chip 104 is electrically coupled to a first portion of metal layer 108 through bond wire 102. Bond wire 102 includes Al, Cu, Al—Mg, Au, or another suitable material. In one embodiment, bond wire 102 is bonded to semiconductor chip 104 and the first portion of metal layer 108 using ultrasonic wire bonding. Semiconductor chip 104 is bonded to a second portion of metal layer 108 by solder joint 106.

Metal layer 108 is bonded to the top of ceramic substrate 110. Metal layer 112 is bonded to the bottom of ceramic substrate 110. Metal layers 108 and 112 are bonded to ceramic substrate 110 using a direct copper bonding (DCB) process, a direct aluminum bonding (DAB) process, an active metal brazing (AMB) process, or another suitable process. Ceramic substrate 110 includes Al₂O₃, AlN, Si₃N₄, or other suitable material. Metal layers 108 and 112 include one or more layers of Cu, Al, Ni, Ag, Au, Pd, or other suitable material. In one embodiment, Cu or Al are bonded to ceramic substrate 110 and Ni, Ag, Au, Pd, or Cu are plated on top of the bonded metals to provide solderable surfaces. Metal layer 112 is joined to base plate 116 by solder joint 114 as previously described above. Base plate 116 includes one or more of Cu, Al, Ni, Ag, Au, Pd, or other suitable metal. In one embodiment, base plate 116 includes Al plated with Ni, Ag, Pd, Au, or Cu. Base plate 116 is coupled to heat sink 118. Heat sink 118 includes Al or another suitable material.

FIG. 2 illustrates a cross-sectional view of another embodiment of a module 120. In one embodiment, module 120 is a power electronic module. Power electronic module 120 includes a metal base plate 124, solder joints 126, metallized ceramic substrates 130 including metal surfaces or layers 128 and 132, solder joints 134, semiconductor chips 136, bond wires 138, a circuit board 140, control contacts 142, power contacts 144, potting 146 and 148, and a housing 150.

Metal layers 128 and 132 are bonded to ceramic substrates 130 using a DCB process, a DAB process, an AMB process, or another suitable process. Ceramic substrates 130 include Al₂O₃, AlN, Si₃N₄, or other suitable material. Metal layers 128 and 132 include one or more layers of Cu, Al, Ni, Ag, Au, Pd, or other suitable material. In one embodiment, Cu or Al are bonded to ceramic substrates 130 and Ni, Ag, Au, Pd, or Cu are plated on top of the bonded metals to provide solderable surfaces. Solder joints 126 join metal layers 128 to metal base plate 124. In one embodiment, solder joints 126 include soft solder and an inter-metallic zone having spikes greater than 10 μm, such as up to 100 μm, and a roughness (R_{z}) of at least 20 μm.

In another embodiment, metal layers 128 include roughness enhancing features, such as trenches, dimples, or other suitable features to increase the roughness of solder joints 126. In one embodiment, the roughness enhancing features are combined with inter-metallic zones having spikes greater than 10 μm, such as up to 100 μm to 200 μm, to provide a roughness (R_{z}) of at least 20 μm. The roughness of solder joints 126 reduces the stress on the solder joints due to thermal cycling, thereby extending the life of power electronic module 120 by preventing a failure of the solder joints.

Semiconductor chips 136 each include one or more IGBTs, MOSFETs, diodes, or other suitable power semiconductors. Semiconductor chips 136 are bonded to metal layers 132 by solder joints 134. In one embodiment, solder joints 134 are replaced by sintered joints formed using a low temperature silver sintering process (e.g., LTJT, NTV). In another embodiment, a transient liquid phase soldering process, which results in an alloy with a melting point greater than 400° C., is used to form joints 134. Contacts on top of semiconductor chips 136 are electrically coupled to metal layers 132 through bond wires 138. Bond wires 138 include Al, Cu, Al—Mg, Au, or another suitable material. In one embodiment, bond wires 138 are bonded to semiconductor chips 136 and metal layers 132 using ultrasonic wire bonding. Metal layers 132 are electrically coupled to circuit board 140 and power contacts 144. Circuit board 140 is electrically coupled to control contacts 142.

Housing 150 encloses solder joints 126, metallized ceramic substrates 130 including metal layers 128 and 132, solder joints 134, semiconductor chips 136, bond wires 138, circuit board 140, portions of control contacts 142, and portions of power contacts 144. Housing 150 includes technical plastics or another suitable material. Housing 150 is joined to metal base plate 124.

Potting material 146 fills areas below circuit board 140 within housing 150 around solder joints 126, metallized ceramic substrates 130 including metal layers 128 and 132, solder joints 134, semiconductor chips 136, and bond wires 138. In one embodiment, potting material 146 includes a soft potting material, such as silicone gel or another suitable material. Potting material 148 fills the area above circuit board 150 within housing 150 around portions of control contacts 142 and portions of power contacts 144. In one embodiment, potting material 148 includes a hard potting material, such as epoxy or another suitable material. Potting material 146 and 148 prevents damage to power electronic module 120 by dielectrical breakdown.

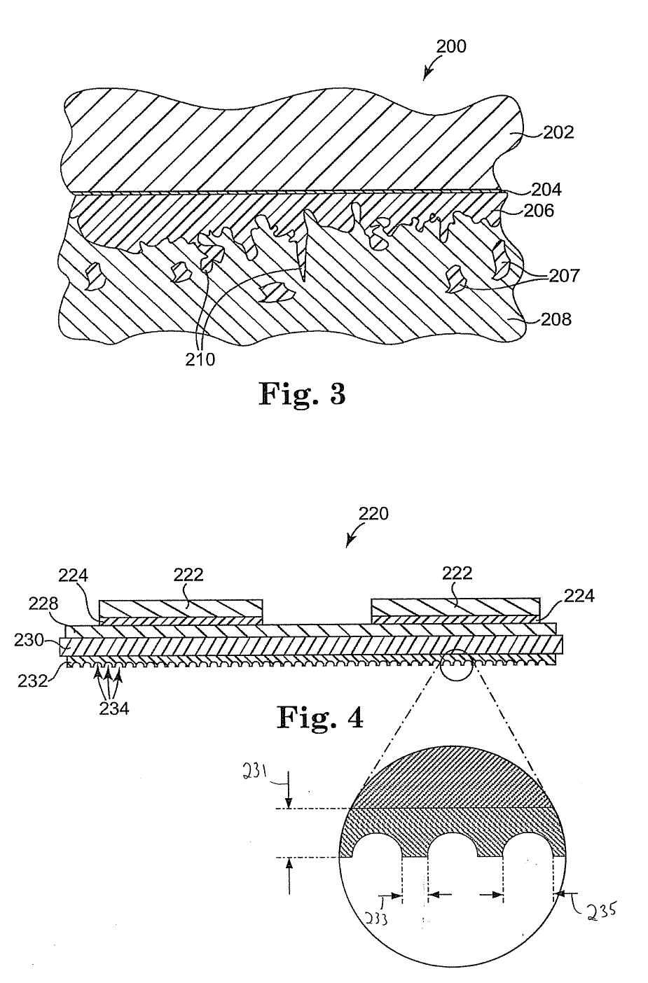

FIG. 3 illustrates a cross-sectional view of one embodiment of a solder joint 200. In one embodiment, solder joint 200 provides solder joint 114 previously described and illustrated with reference to FIG. 1 and solder joints 126 previously described and illustrated with reference to FIG. 2. In another embodiment, solder joint 200 provides solder joint 106 previously described and illustrated with reference to FIG. 1 or solder joints 134 previously described and illustrated with reference to FIG. 2.

Solder joint 200 joins a metal layer 202 of a metallized substrate to a metal base plate (not shown). In one embodiment, metal layer 202 includes an optional surface metal 204 that is different from the metal used for metal layer 202. In one embodiment, metal layer 202 includes Cu, Ni, Ag, or another suitable metal. Optional surface metal 204 includes a plated layer of Ni, NiAu, Ag, NiPd, Cu, or another suitable solderable metal or alloy.

Metal layer 202 or optional surface metal 204 contacts an inter-metallic zone 206, which includes an inter-metallic alloy. Inter-metallic zone 206 contacts soft solder 208, which contacts a base plate (not shown). In addition, islands of inter-metallic alloy 207 may be embedded within soft solder 208. In one embodiment, the inter-metallic alloy includes Sn—Cu, such as Cu₃Sn or Cu₆Sn₅. In other embodiments, the inter-metallic alloy includes SnₐCu_{b}X_{c} or other suitable inter-metallic alloy that is formed during the soldering process, where X is a third metal, such as Ni, Ag, or another suitable metal that accelerates the formation of the alloy.

In one embodiment, surface metal 204 includes a solderable metal that supports the formation of a thick and rough inter-metallic zone 206 during soldering. In one embodiment, surface metal 204 includes Cu, Ni, Ag, or another suitable material to support the formation of SnₐCu_{b} inter-metallic alloys. In another embodiment, surface metal 204 includes solderable metal that includes activators, accelerators, and/or catalysts that support the formation of a thick and rough inter-metallic zone 206 during soldering.

In another embodiment, a thick and rough inter-metallic zone 206 is achieved by using a special soldering process defined by an increased maximum temperature and/or time. In one embodiment, the solder includes more than 50% of Sn, such as more than 80% of Sn, in a Sn—Cu, Sn—Ag, Sn—Ag—Cu, Sn—Sb, Sn—Ag—Sb, or other suitable solder. After the special soldering process, inter-metallic zone 206 includes spikes 210 of inter-metallic alloy reaching a range between approximately 10 μm to 100 μm into soft solder 208. The maximum soldering temperature is greater than 80° C. above the solidus of the solder, such as greater than 110° C., 130° C., or 160° C. In one embodiment, the soldering temperature is approximately 350° C. for at least 20 seconds, such as 180 seconds. In another embodiment, the soldering temperature is at least 330° C. for at least 50 seconds.

In another embodiment, surface metal 204 includes a solderable material that is suitable for forming inter-metallic zones during the soldering process. The base plate, which is joined at the bottom interface of soft solder 208, includes activators, accelerators, and/or catalysts that support the formation of a thick and rough inter-metallic zone 206 at the upper surface of the solder (i.e., at surface metal 204) during soldering. During the soldering process, once the solder liquefies, the activators, accelerators, and/or catalysts diffuse through the solder. In one embodiment, the activators include Cu, Ni, Ag, or another suitable material.

In another embodiment, at least one surface, either the base plate or surface metal 204 includes a base Cu or Cu alloy that supports the acceleration of the formation of inter-metallic zone 206 on surface metal 204. In another embodiment, the solder includes Cu particles, Ni particles, Ag particles, or other suitable activating metals that support the formation of ternary or higher alloys thus accelerating the formation of inter-metallic zone 206. In another embodiment, solder layers within a range of approximately 50 μm to 150 μm are used such that inter-metallic zone 206, including spikes 210, extends throughout soft solder 208.

FIG. 4 illustrates a cross-sectional view of one embodiment of a portion 220 of a module including a metallized substrate 230 including roughness enhancing features 234. Portion 220 of the module includes semiconductor chips 222, solder joints 224, and metallized ceramic substrate 230 including metal surfaces or layers 228 and 232. Semiconductor chips 222 are joined to metal layer 228 of metallized substrate 230 by solder joints 224.

Metal layer 232 includes roughness enhancing features 234, such as trenches, dimples, or other suitable features. In one embodiment, each roughness enhancing feature 234 has a depth 231 greater than 20 μm, such as greater than 50 μm or greater than 100 μm. The lateral spacing 233 between roughness enhancing features 234 is equal to the diameter 235 of each roughness enhancing feature 234 or another suitable value. The diameter 235 of each roughness enhancing feature 234 is up to approximately 1 mm, such as 20 μm, 50 μm, 100 μm, or another suitable value.

Roughness enhancing features 234 may be etched into metal layer 232 or formed using another suitable method. Roughness enhancing features 234 provide increased roughness to the solder joint when metal layer 232 is soldered to a base plate. In one embodiment, metal layer 232 including roughness enhancing features 234 provides metal layer 112 previously described and illustrated with reference to FIG. 1 or metal layers 128 previously described and illustrated with reference to FIG. 2. In one embodiment, roughness enhancing features 234 are used in combination with an inter-metallic zone 206 as previously described and illustrated with reference to FIG. 3.

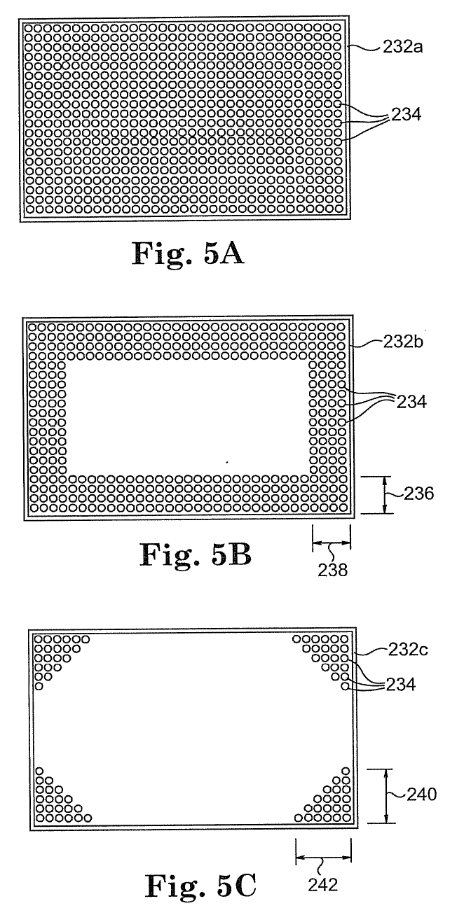

FIG. 5A illustrates a bottom view of one embodiment of a metallized substrate including a metal layer 232a having roughness enhancing features 234. In this embodiment, roughness enhancing features 234 cover the entire surface of metal layer 232a. While roughness enhancing features 234 illustrated in FIG. 5A include dimples, in other embodiments any suitable roughness enhancing features that increase the roughness of the surface of metal layer 232a are used.

FIG. 5B illustrates a bottom view of another embodiment of a metallized substrate including a metal layer 232b having roughness enhancing features 234. In this embodiment, roughness enhancing features 234 cover the outer edges of the surface of metal layer 232b. Roughness enhancing features 234 extend from the outer edge of the surface of metal layer 232b by a first distance indicated by 236 on first sides of metal layer 232b and by a second distance indicated by 238 on second sides of metal layer 232b, where the second sides are perpendicular to the first sides. In one embodiment, distance 236 equals distance 238. In one embodiment, distances 236 and 238 are greater than or equal to 10 mm. While roughness enhancing features 234 illustrated in FIG. 5B include dimples, in other embodiments any suitable roughness enhancing features that increase the roughness of the surface of metal layer 232b are used.

FIG. 5C illustrates a bottom view of another embodiment of a metallized substrate including a metal layer 232c having roughness enhancing features 234. In this embodiment, roughness enhancing features 234 form a triangle at each corner of metal layer 232c. Roughness enhancing features 234 extend from each corner of the surface of metal layer 232c by a first distance indicated by 240 on first sides of metal layer 232c and by a second distance indicated by 242 on second sides of metal layer 232c, where the second sides are perpendicular to the first sides. In one embodiment, distance 240 equals distance 242. In one embodiment, distances 240 and 242 are greater than or equal to 10 mm. While roughness enhancing features 234 illustrated in FIG. 5C include dimples, in other embodiments any suitable roughness enhancing features that increase the roughness of the surface of metal layer 232c are used.

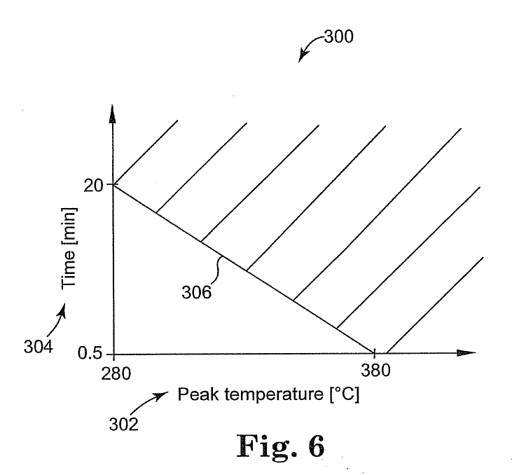

FIG. 6 is a graph 300 illustrating one embodiment of soldering temperatures versus time for forming an inter-metallic zone, such as inter-metallic zone 206 previously described and illustrated with reference to FIG. 3. Graph 300 includes peak soldering temperature in degrees Celsius on x-axis 302 using a log scale and time in minutes on y-axis 304. In one embodiment, to form an inter-metallic zone 206 as previously described and illustrated with reference to FIG. 3, a soldering temperature and time within the range as indicated at 306 is used. As indicated at 306, as the peak soldering temperature increases, the soldering time decreases. As the peak soldering temperature decreases, the soldering time increases. For example, in one embodiment, the soldering temperature is approximately 350° C. for 3 minutes to provide an inter-metallic zone 206 including spikes 210 up to 100 μm and a roughness (R_{z}) of at least 20 μm.

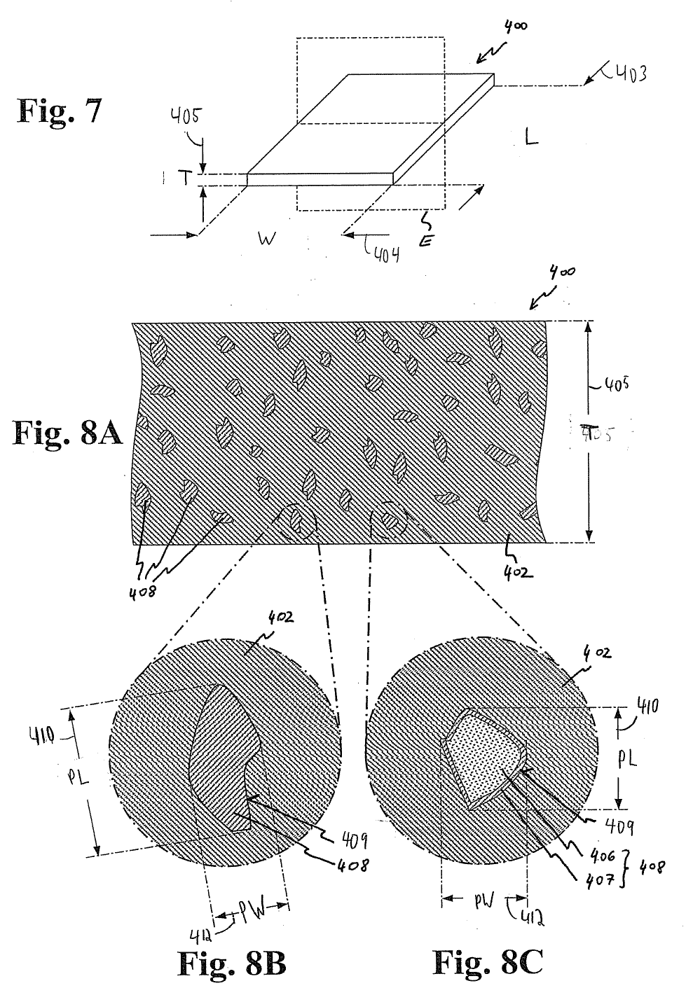

FIG. 7 illustrates a perspective view of one embodiment of a solder pad, plate, or preform 400. Solder pad 400 is a flat, substantially planar solder pad. Solder pad 400 has a length (L) indicated at 403, a width (W) indicated at 404, and a thickness (T) indicated at 405. The length 403, width 404, and thickness 405 of solder pad 400 is selected based on the particular application. In one embodiment, the length 403 is at least approximately 5 mm and/or the width 404 is at least approximately 5 mm. In one embodiment, the thickness 405 is within a range between approximately 0.05 mm and approximately 0.5 mm.

FIG. 8A illustrates a cross-sectional view of one embodiment of solder pad 400 illustrated in FIG. 7 in a sectional plane E. Solder pad 400 includes a soft solder 402 (i.e., a solder having a liquidus temperature of less than 450° C.). For example, soft solder 402 may be SnAg_{3,5} or other suitable soft solder. In addition, solder pad 400 includes particles 408 that are embedded in soft solder 402. In one embodiment, particles 408 are distributed substantially homogeneously in solder pad 400. In one embodiment, particles 408 make up between approximately 10 Vol % and 60 Vol % of solder pad 400.

FIGS. 8B and 8C illustrate magnified views of embodiments of particles 408. Particles 408 have a rod-like shape, a stripe-like shape, a pad-like shape, or another suitable shape. Each of the particles 408 has a maximum length (PL) indicated at 410 and a maximum width (PW) indicated at 412. The maximum width 412 is measured in a lateral direction that is perpendicular to the longitudinal direction in which the maximum length 410 is measured. Different particles 408 have equal or different maximum lengths 410 and/or equal or different maximum widths 412. Particles 408 serve to inhibit the propagation of cracks that may occur in a soldered connection produced by use of solder pad 400 (i.e., the growth of a crack in the soldered connection will be stopped as soon as the crack hits a particle 408). Hence, the resistance of a soldered connection between components having different coefficients of thermal expansion to thermal cycling is improved. In one embodiment, particles 408 effect a precipitation hardening in the soldered connection.

In one embodiment, particles 408 have a metallic surface 409. FIG. 8B illustrates an embodiment in which the metallic surface 409 is realized by particles 408 made of a metal. In another embodiment as illustrated in FIG. 8C, a metallic surface 409 is realized by a metallic coating 407 of a carrier particle 406. Such a carrier particle 406 is metallic or non-metallic. In one embodiment, a non-metallic carrier particle 406 is made of a dielectric material, such as a ceramic material or another suitable non-metallic material. In one embodiment, a particle 408 made of metal as illustrated in FIG. 8B or a metallic coating 407 as illustrated in FIG. 8C is made of a pure metal, for example, of copper (Cu), nickel (Ni), or iron (Fe). In another embodiment where a soft solder 402 including tin (Sn) is used, a particle 408 made of metal as illustrated in FIG. 8B or a metallic coating 407 as illustrated in FIG. 8C is made of a tin including an inter-metallic phase or alloy, such as CuₓSn_{y}, NiₓSn_{y}, AgₓSn_{y}, or SnₓSb_{y}. In another embodiment where a soft solder 402 including indium (In) or gallium (Ga) is used, a particle 408 made of metal as illustrated in FIG. 8B or a metallic coating 407 as illustrated in FIG. 8C is made of an indium or gallium including inter-metallic alloy such as CuₓIn_{y}, NiₓIn_{y}, CuₓGa_{y}, NiₓGa_{y}, GaₓSbₓ, or InₓSbₓ. Composition examples for inter-metallic alloys include Cu₃Sn, Cu₆Sn₅, Ni₃Sn, Ni₃Sn₂, Ni₃Sn₄, Ag₃Sn, Cu₁₁In₉, Cu₇In₃, Cu₂In, Ni₂₈In₇₂, Ni₂In₃, Ni₃In, Ni₂In, CuGa (Cu₃₄ at % Ga₆₆ at %), NiGa₄, Ni₂Ga₃, Ni₃Ga₄, β-Sn₃Sb₂, α-GaSb, and α-InSb. In other embodiments, ternary inter-metallic alloys are used.

In one embodiment where particles 408 are made of or coated with an inter-metallic phase material, suitable soft solders 402 include pure metals such as tin (Sn), indium (In), bismuth (Bi), lead (Pb), antimony (Sb), or gallium (Ga), or soft solder alloys such as SnₓAg_{y}Cu_{z}, SnₓIn_{y}, SnₓPb_{y}Ag_{z}Cuₓ, SnₓSb_{y}, and SnₓBi_{y}Ag_{z}Cuₓ. The melting point of tin (Sn) containing soft solders should be lower than or equal to approximately 250° C. The melting point of indium containing soft solders should be lower than or equal to approximately 170° C.

In one embodiment, particles 408 have a maximum length 410 greater than or equal to approximately 50 μm. In one embodiment, the average of the maximum lengths 410 of particles 408 having lengths 410 of more than 50 μm range, for example, from approximately 0.2 times the thickness 405 of solder pad 400 to 0.8 times the thickness 405 of solder pad 400. In another embodiment, the average of the maximum lengths 410 of particles 408 having lengths 410 of more than 50 μm range, for example, from approximately 0.3 times the thickness 405 of solder pad 400 to 0.6 times the thickness 405 of solder pad 400. In another embodiment, in addition to or alternatively to the average of the maximum lengths 410 described above, the average of the maximum widths 412 of particles 408 having lengths 410 of more than 50 μm range, for example, from 1 μm to the average of the maximum lengths 410, and/or from 0.01 times the thickness 405 of solder pad 400 to 0.20 times the thickness 405 of solder pad 400. The maximum width 412 of a particle 408 is considered to be the maximum of all its dimensions perpendicular to the longitudinal direction.

Further, in one embodiment, the average of the thicknesses of particles 408 having maximum lengths 410 of more than 50 μm range from 1 μm to the average of the maximum lengths 410, and/or from 1 μm to 30 μm. The thickness of a particle 408 is considered to be the maximum of all its dimensions perpendicular to the longitudinal direction and perpendicular to the direction of its thickness. In one embodiment, the average of the thicknesses is the mean of the thicknesses of particles 408 having lengths 410 of more than 50 μm.

Except for the values dependent on the thickness 405 of solder pad 400, the above mentioned values for the dimensions of particles 408 also apply to the respective dimensions of particles embedded in a soft solder of a soldering paste.

Using such a solder pad or such a soldering paste, a soldered connection between two components may be produced. In this case, the above mentioned values for the dimensions of particles 408 also apply to the respective dimensions of the particles after the soldering process. As far as the above-mentioned values depend on the thickness 405 of solder pad 400, the thickness 405 of solder pad 400 is replaced by the thickness of the solder joint.

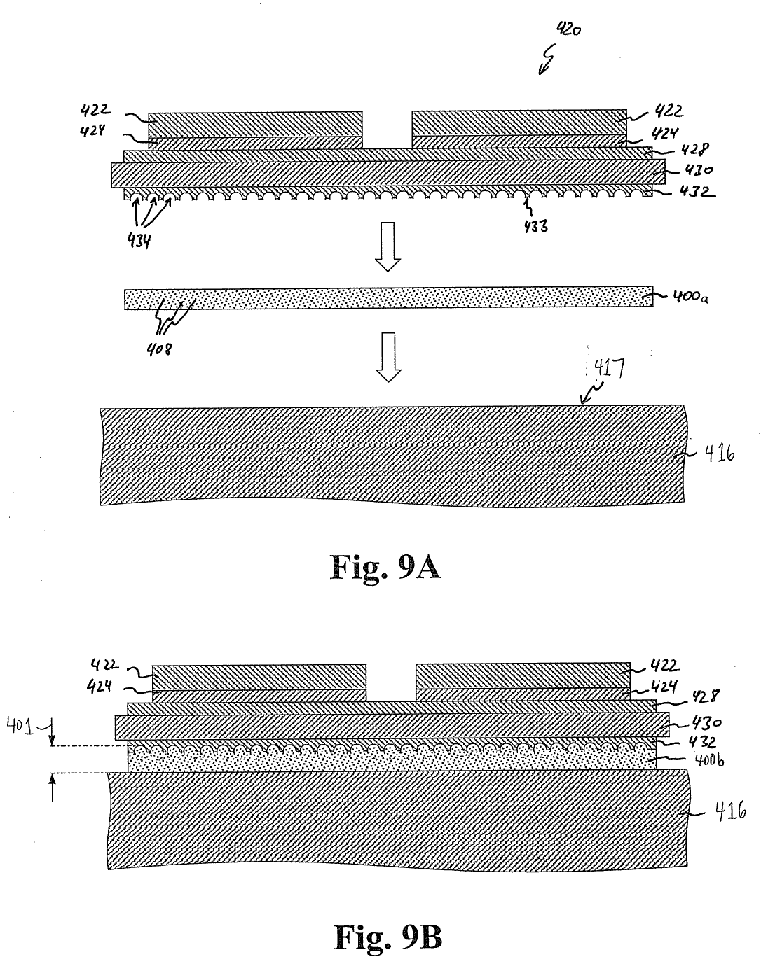

FIGS. 9A and 9B illustrate one embodiment of a method for producing a solder joint between a part 420 of a module and a metal base plate 416. Part 420 includes a substrate 430. Substrate 430 includes a top metallization 428 and a bottom metallization 432, and is equipped with semiconductor chips 422 soldered to top metallization 428. Between each of the semiconductor chips 422 and top metallization 428, the module includes a solder joint 424. The bottom metallization 432 includes roughness enhancing features 434. In one embodiment, the top metallization 428 and/or the bottom metallization 432 is coated with another metal to improve solderability. In one embodiment, part 420 of the module is similar to module 220 previously described and illustrated with reference to FIG. 4. Further, in one embodiment, metal base plate 416 is similar to metal base plates 116 and/or 124 previously described and illustrated with reference to FIGS. 1 and 2, respectively.

To produce a solder joint between part 420 and metal base plate 416, a solder 400a is arranged between bottom metallization 432 and metal base plate 416. For example, solder 400a may be a solder pad or a soldering paste as previously described and illustrated with reference to FIGS. 7, 8A, 8B, and 8C. The solder is placed on the top side 417 of metal base plate 416 and/or on the bottom side 433 of bottom metallization 432. After arranging part 420, solder 400a, and metal base plate 416 such that solder 400a is in contact with both bottom metallization 432 and metal base plate 416, solder 400a is melted and then cooled to form a solder joint 400b between part 420 and metal base plate 416 as illustrated in FIG. 9B. In one embodiment during the soldering, particles 408 grow in size as inter-metallic alloys are formed for the inter-metallic zone, such as inter-metallic zone 206 previously described and illustrated with reference to FIG. 3. In one embodiment, the thickness 401 of solder joint 400b is between approximately 10 μm and 1000 μm.

In the following, a method for producing an inter-metallic phase material that can be used to form a particle 408 as described with reference to FIG. 8B, or to form a coating 407 as described with reference to FIG. 8C, will be described using the example of producing Cu₆Sn₅. In other embodiments, a similar process is used to produce other suitable inter-metallic phase materials that can be used to form a particle 408 as described with reference to FIG. 8B, or to form a coating 407 as described with reference to FIG. 8C.

Copper (Cu) and tin (Sn) are mixed in the correct ratio, then melted, quenched, and post-aged for a predefined duration at a temperature below the melting point of the inter-metallic phase to be produced (i.e., in the present example, below 415° C.). The result is a mixture of materials that includes the spatial areas of inter-metallic phase Cu₆Sn₅ and tin. The size of the spatial areas of inter-metallic phase Cu₆Sn₅ increases with the duration of the post-ageing step. In one embodiment, following post-ageing, the undesirable tin but not the inter-metallic phase Cu₆Sn₅ is selectively etched off, using, for example, 5 Vol % 32% iger hydrochloric acid and 95 Vol % Ethanol as etchant. Then, the remaining mixture of materials is pressed, deformed, cut, and/or grinded to obtain particles 408 having a desired size or to provide a powder that substantially includes the inter-metallic phase Cu₆Sn₅.

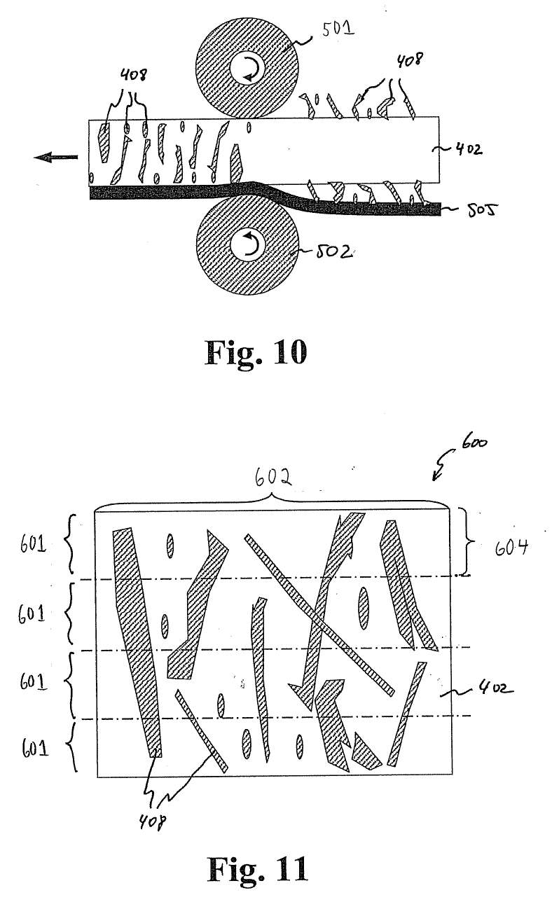

To produce a solder pad 400 as described with reference to FIGS. 7, 8A, and 8B, in one embodiment such particles 408 are rolled in a solder pad made of or including soft solder 402. In one embodiment, such a solder pad has similar dimensions to solder pad 400 previously described and illustrated with reference to FIG. 7. As illustrated in FIG. 10, a solder pad made of or including soft solder 402 is strewed on its top side with particles 408. Then, on its bottom side, further particles 408 are fed on a feed band 505 that is rolled, together with the solder pad and particles 408, between a pair of rollers 501 and 502 to press particles 408 into soft solder 402. The result is a solder pad 400 including particles 408 as illustrated in FIGS. 7 and 8A. In other embodiments, other particles 408 as previously described and illustrated with reference to FIGS. 8A, 8B, and 8C are pressed into a soft solder 402 in a similar way. In one embodiment, a solder pad produced in this way is used as previously described and illustrated with reference to FIGS. 9A and 9B.

In another embodiment, instead of or in addition to pressing particles 408 into a soft solder, particles 408 are also spread over a soft solder paste that is applied to a metallic surface to be soldered. In a following soldering step, the soft solder is melted so that the particles migrate into and distribute throughout the soft solder.

In a further method for producing a solder that includes particles 408 made of an inter-metallic phase as described with reference to FIGS. 7, 8A, and 8B, the substances of the inter-metallic phase to be produced are mixed in the correct ratio, then melted, quenched, and post-aged for a predefined duration at a temperature below the melting point of the inter-metallic phase to be produced (i.e., in the above-mentioned example of Cu₅Sn₆, below 415° C.). The result is a mixture of materials that includes the spatial areas of inter-metallic phase Cu₆Sn₅ and tin as previously described above. Then, this mixture may be—without etching off the tin—pressed, deformed, cut, and/or grinded to obtain particles 408 having a desired size and then quickly distributed in a molten soft solder. As illustrated in FIG. 11, after cooling down the mixture, a block 600 of soft solder 402 including particles 408 remains. Cooling down of the mixture is executed rapidly to keep particles 408 substantially solid (i.e., there is no substantial change of the block's melting point). The block 600 is then cut into solder pads 601 having a thickness 604 of, for example, about 300 μm, and/or a size 602 of, for example, 3 cm×6 cm. In particular, block 600 may be cut into solder pads having similar dimensions to solder pad 400 previously described and illustrated with reference to FIG. 7. The size and thickness of the solder pad may be adapted to the intended application.

In one embodiment, in a solder or in a solder joint that includes particles for inhibiting the propagation of cracks, the amount of particles having a length of at least 50 μm ranges, for example, from 10 Vol % to 60 Vol %. It is intended that these particles are not fused during the soldering process as fusing would degrade the crack propagation inhibiting characteristic of the solder joint. Further, the hardness of such particles may be greater than the hardness of the ambient soft solder.

The surfaces of two components that are to be joined by soldering need to be solderable. In one embodiment, to obtain a solderable surface or to improve the solderability of a component, the component is coated with a solderable layer. For example, copper (Cu) or nickel (Ni) are suitable materials that can be used for such a coating.

With reference in particular to the joint between a bottom metallization 112, 128, 232, or 432 of a ceramic substrate 110, 130, 230, or 430 illustrated in FIGS. 1, 2, 4, 9A, and 9B and a metal base plate 116, 124, and 416 illustrated in FIG. 1, 2, 9A, or 9B, the metal base plate may be, for example, made of copper and/or coated with nickel. Further, the bottom surface of the bottom metallization that is soldered to a metal base plate may be made of copper or aluminum and optionally be coated, for example, with copper or nickel.

Further, in one embodiment, the surfaces of two components that are to be joined by soldering are coated with a protection coating that volatilizes or dissolves during the soldering process to protect the surface against chemical modifications like oxidation; as such modifications may adversely affect the solderability. In case of an existing layer for obtaining or improving the solderability, such layer is applied prior to the protection layer. For example, suitable materials for protection layers are silver (Ag), gold (Au), or organic surface protection layers.

Embodiments provide solder joints including soft solder and an inter-metallic zone having spikes of as least 10 μm, such as up to 100 μm, and a roughness of at least 20 μm. In one embodiment, a metal layer to be soldered includes roughness enhancing features, such as trenches, dimples, or other suitable features to increase the roughness of the solder joint and to enhance the growth of the inter-metallic zone. In another embodiment, particles, such as particles including an inter-metallic phase are introduced into the solder. The roughness of the solder joint and the particles reduce the stress on the solder joint due to thermal cycling, thereby preventing a failure of the solder joint.

While the illustrated embodiments substantially focused on power electronic modules, the embodiments are applicable to any modules where a solder joint capable of withstanding thermal cycling is desired.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A solder comprising:
a soft solder having a melting point less than 450° C.; and
particles embedded in the soft solder, each particle having a maximum length greater than 50 μm,
wherein the particles comprise greater than 10 Vol % and less than 60 Vol % of the solder.

2. The solder of claim 1, wherein the particles comprise an inter-metallic alloy.

3. The solder of claim 2, wherein the particles comprise a dielectric material coated with the inter-metallic alloy.

4. The solder of claim 2, wherein the soft solder comprises tin, and
wherein the inter-metallic alloy comprises at least one of SnₓSb_{y}, CuₓSn_{y}, NiₓSn_{y}, and AgₓSn_{y}.

5. The solder of claim 2, wherein the soft solder comprises at least one of indium and gallium, and
wherein the inter-metallic alloy comprises at least one of GaₓSb_{y}, InₓSb_{y}, CuₓIn_{y}, NiₓIn_{y}, CuₓGa_{y}, and NiₓGa_{y}.

6. The solder of claim 1, wherein the soft solder is a pure metal.

7. The solder of claim 6, wherein the pure metal is one of tin, iron, bismuth, lead, and gallium.

8. The solder of claim 1, wherein the soft solder comprises an alloy.

9. The solder of claim 8, wherein the alloy comprises one of SnₓAg_{y}Cu_{z}, SnₓIn_{y}, SnₓPb_{y}Ag_{z}Cuₓ, SnₓSb_{y}, SnₓAg_{y}Sb_{z}, and SnₓBi_{y}Ag_{z}Cuₓ.

10. The solder of claim 1, wherein the particles comprise a pure metal.

11. The solder of claim 10, wherein the particles comprise a dielectric material coated with the pure metal.

12. The solder of claim 10, wherein the particles comprise at least one of copper, nickel, and iron.

13. The solder of claim 1, wherein the solder is a solder paste.

14. A solder comprising:
a soft solder having a melting point less than 450° C.; and
particles embedded in the soft solder, each particle having a maximum length greater than 50 μm,
wherein the particles comprise greater than 10 Vol % and less than 60 Vol % of the solder; and
wherein the solder provides a solder preform.

15. The solder of claim 14, wherein an average maximum length of the particles is greater than 0.1 times a thickness of the solder preform and less than 0.8 times the thickness of the solder preform.

16. The solder of claim 15, wherein an average maximum width of the particles is greater than 0.2 times the thickness of the solder preform and less than 0.6 times the thickness of the solder preform.

17. A method for producing a solder, the method comprising:
providing a soft solder having a melting point below 450° C.;
providing a plurality of particles having a length greater than 50 μm; and
introducing the plurality of particles into the soft solder.

18. The method of claim 17, wherein providing the soft solder comprises providing a plate of soft solder.

19. The method of claim 17, wherein providing the particles comprises providing particles comprising an inter-metallic alloy.

20. The method of claim 19, wherein providing the particles comprises providing particles comprising a dielectric material coated with the inter-metallic alloy.

21. The method of claim 19, wherein providing the particles comprises providing particles comprising at least one of SnₓSb_{y}, GaₓSb_{y}, InₓSb_{y}, CuₓSn_{y}, NiₓSn_{y}, AgₓSn_{y}, CuₓIn_{y}, NiₓIn_{y}, CuₓGa_{y}, and NiₓGa_{y}.

22. A module comprising:
a metallized substrate including a metal layer;
a base plate; and
a joint joining the metal layer to the base plate, the joint comprising solder contacting the base plate and an inter-metallic zone contacting the metal layer and the solder, the inter-metallic zone having spikes up to 100 μm and a roughness (R_{z}) of at least 20 μm, the solder comprising soft solder having a melting point less than 450° C. and particles distributed in the soft solder, each particle having a maximum length greater than 50 μm, wherein the particles comprise greater than 10 Vol % and less than 60 Vol % of the joint.

23. The module of claim 22, wherein the metal layer comprises roughness enhancing features.

24. The module of claim 23, wherein the roughness enhancing features comprises trenches or cavities.

25. The module of claim 24, wherein the trenches or cavities have a diameter of at least 20 μm and a depth of at least 20 μm.
